(19) United States
(12) Patent Application Publication
(10) Pub. No.: US 2003/0107478 A1
(43) Pub. Date: Jun. 12, 2003

(54) Architectural sound enhancement system

(76) Inventors: Richard S. Hendricks, Lancaster, PA (US); Kenneth P. Roy, Holtwood, PA (US)

Correspondence Address: Womble Carlyle Sandridge & Rice, PLLC, P.O. Box 7037, Atlanta, GA, 30357-0037, US

(21) Appl. No.: 10/008,405

(22) Filed: Dec. 6, 2001

(51) Int. Cl. G08B 3/00

(52) U.S. Cl. 340/311.2

(57) ABSTRACT

An architectural sound enhancement system is provided for installation in a space having a suspended ceiling to provide integrated masking, background, and paging functions. The system includes an array of flat panel speaker units, a central paging transmitter, and a wireless remote control unit. The speaker units are adapted to be installed in a selected location within a suspended ceiling grid and can be moved to a new location as needed and desired. Each speaker unit is self-contained and includes, in one embodiment, an electronics module housing a system controller with radio frequency detection capability, a sound generator having a library of stored sounds, an audio effects processor including an equalizer, a sound enhancer, an audio pre-amplifier, an audio power amplifier, and a flat panel speaker. The system controller is adapted to receive control signals from the remote control unit and to control the volume and equalization of the speaker unit as well as to select sounds from the sound library for reproduction and to upload new sounds from the remote control unit to the library. Paging announcements are transmitted wirelessly from the central paging transmitter and received by selected ones of the speaker units for broadcasting a page or other audio message.

### TECHNICAL FIELD

This invention relates generally to sound reinforcement and enhancement systems and more particularly to masking, paging, and background sound systems for an interior workspace.

### BACKGROUND OF THE INVENTION

Noise in the workplace is not a new problem, but it is one that is garnering increasing attention as workplace configurations and business models evolve. A number of recent studies indicate that noise, and particularly conversations of others, is the single largest distraction within the workplace and has a significant negative impact on worker productivity. As the service sector of the economy grows, more and more workers find themselves in offices rather than manufacturing facilities. The need for flexible, re-configurable space has resulted in open plan workspaces; large rooms with reduced ceiling height and moveable reconfigurable partitions that define the workstations or cubicles of workers. Unfortunately, distracting sounds tend to propagate over and through the partition walls to disturb workers in adjacent workstations. In addition, the density of workstations is increasing with more workers occupying a given physical space. Further, more workers use speakerphones and conferencing technologies, and computers with large sound reflective screens, personal sound systems, and even voice recognition systems for communicating vocally with the computer. All of these factors, and others, have contributed to the progressive increase in the level of distracting noises and their corresponding negative impact on productivity within the workplace.

In closed spaces, particularly in office and meeting room settings, speech intelligibility and the acoustic characteristics of the room are determined by a number of factors including room shape, furnishings, the number of occupants, how well the room is acoustically isolated, and especially floor, wall, and ceiling treatments. The acoustic characteristics of the room, as determined by these and other factors, determines how much sound intrusion will occur as well as how sensitive listeners will be affected by extraneous noise, such as conversational distractions.

A more general examination of the interior environment of a space reveals other aspects that play a major role in how sound is perceived by occupants. Recent research has indicated that when considering the issue of the acoustical properties of a space, the transmission loss and sound absorption characteristics of materials are not the only contributors to the perceived acoustical environment. Another factor is the level and acoustical characteristics of background noise in the space. Background noise includes, for example, sounds produced by overhead utilities such as HVAC systems and their related ductwork and, most significant to the present invention, and the focus of much current research, distracting sounds, much of it conversational, that intrudes the space from adjacent spaces. Sound can intrude into a space, particularly in an office setting, in a variety of ways including, for example, the following:

through walls or partitions,

through open areas such as doorways, hallways, and over partitions,

through HVAC ductwork, registers, and diffusers,

by reflection off the ceiling and over partitions,

through suspended ceiling panels, across the utility plenum, and back through the ceiling,

through the structural ceiling deck, the utility plenum, and the suspended ceiling, from above and conversely in multi-story buildings, and

through the ceiling, utility plenum, and ceiling deck/floor from below in multiple story buildings.

Generally two approaches have been taken to mitigate the presence of distracting sounds in a space. The distracting sound can be attenuated as it travels from its source to minimize its intrusion into adjacent spaces or it can be covered up or masked by introducing acoustically and spatially tailored masking sounds into the space. Sound attenuation is not always practical, especially in workspaces made up of partitioned cubicles and open doorways and hallways. As a result, masking techniques have increasingly been employed to neutralize distracting sounds. A recent paper asserts that:

Sound masking systems are one of the more critical elements in preventing conversational speech from being a distraction in the work environment. They are necessary even when high performance ceiling systems and furniture systems have been installed because they ensure that when the variable air volume systems are moving low quantities of air, enough background ambient sound is present to prevent conversations from being overheard and understood. Sound masking provides electronically generated background sound to achieve normal levels of privacy. (Excerpted from Sound Solutions, a professional paper sponsored by ASID, Armstrong World Industries, Dynasound, Inc., Milliken & Co., and Steelcase, Inc.)

The principles of sound masking involve the introduction into a space of sound that has been tailored to have predetermined frequency, volume, and sound quality characteristics effective to mask the targeted distracting noises. The introduction of masking sounds with a predetermined frequency profile within the frequency spectrum of the human voice, for example, provides a masking effect, in essence drowning out distracting human conversations in a way that is not noticeable to an occupant. A typical sound masking system may include a “pink noise” generator, an audio effects unit or filter for tailoring the pink noise to have the appropriate frequency and sound quality characteristics, an audio amplifier, and a system of transducers or loudspeakers arrayed to create the most uniform sound field possible within the space. In fact, uniformity of the masking sound field is a key factor in rendering the masking sounds undetectable by occupants. Otherwise, the changing levels of masking sound as one moves throughout a space are detected and render the masking sounds noticeable.

Prior art masking sound systems typically use an array of traditional dynamic loudspeakers configured and driven in such a way as to create the most uniform sound field possible. The problem with this approach is that typical loudspeakers have an acoustic radiation pattern that is significantly dependent upon the frequency of sounds being reproduced. At very low frequencies, for example, loudspeakers create a sound field that is broad and fairly uniform. As the frequency of the reproduced sound increases, however, the sound field produced by the loudspeaker becomes more focused and directed. Since frequencies of effective masking sounds in a work environment are relatively high, conventional dynamic loudspeakers produce a directed coherent sound field at these frequencies. The use of traditional loudspeakers in sound masking systems has, therefore, presented a real problem for the designers of such systems in obtaining a spatially uniform masking sound field. The problem is exacerbated by the fact that reflections from surfaces and the mixing of the directional sound fields can result in interference patterns, which result in spatial variances of the sound filed, rendering it discernable and potentially annoying to occupants.

One prior art masking sound system uses traditional dynamic loudspeakers mounted above a ceiling on 12 to 16-foot centers, as illustrated in FIG. 1 annexed hereto. Referring to FIG. 1, an array of conventional dynamic loudspeakers 100 is mounted above a suspended ceiling 101 and the speakers are driven by a masking or background sound generator 105 through traditional wiring 106. The loudspeakers are disposed in the plenum space between the suspended ceiling 101 and the hard ceiling 102 and are oriented to direct sound upwardly toward the hard ceiling 102. This provides a longer path for the masking sound to travel and further disburses or diffuses the sound depending upon the surface treatment on the hard ceiling 102. The sound reflects from and is diffused by the hard ceiling and passes downwardly through the ceiling tiles of the suspended ceiling, which may further diffuse the sound, and into the space occupied by occupants 104. The desired result of this arrangement is the creation of a relatively diffuse uniform sound field within the space, as indicated by the arrows.

While such an arrangement is somewhat effective, it nevertheless has problems and shortcomings. For instance, because of the long path of travel within the plenum and the natural absorption of the hard ceiling and ceiling panels, considerable additional power is required to create the desired sound level within the space. Further, the system, once installed, is relatively static and cannot easily be reconfigured to suit a changing space configuration. In addition, the output of each loudspeaker cannot be independently controlled, and therefore the sound field within the space can still vary due to factors such as differing configurations of the hard ceiling, vents and other fixtures in the suspended ceiling, lighting fixtures in the suspended ceiling, and others. Accordingly, this approach has not been entirely successful.

FIG. 2 illustrates another prior art approach to providing masking sounds using traditional dynamic loudspeakers 108, which are suitable for paging, mounted within the ceiling tiles 101 of a suspended ceiling on 12 to 16-foot centers. The loudspeakers are driven by a paging system including a paging generator 107 through traditional wiring 106. The paging system is capable of delivering masking noise signals as well as paging signals to the loudspeakers. Since the loudspeakers 108 are for paging, they have a relatively wide dynamic frequency range necessary to produce the array of harmonics, formatives, and accent sounds contained in intelligible speech. Because the loudspeakers are mounted in the suspended ceiling panels and direct their sound down into the space, the sound has a substantially shorter distance to travel than in the system of FIG. 1. This shorter distance in conjunction with the inherently directional nature of the loudspeakers at frequencies of interest for masking results in a sound field within the space that is not uniform and therefore that usually is perceptible by occupants of the space. In addition, the sound from adjacent loudspeakers in the array can interfere, resulting in perceptible interference patterns or “beating” of the composite sound field within the space. As a result, even though paging and masking is accomplished with a single system, the quality of the masking that results is low and the masking sound field itself generally is perceptible and thus can be annoying to occupants.

Other attempts to provide uniform imperceptible masking sound fields have included delivering time shifted signals to adjacent loudspeakers to prevent interference patterns and diffuse the sound, delivering separate masking sound signals to adjacent loudspeakers, providing dynamic equalization to compensate for varying loudness and room acoustics, and providing a master and slave loudspeakers within selected regions of the space with the group being driven by a masking sound signal tailored to the specific region. While such configurations have met with varied success, they nevertheless have not been entirely acceptable because, among other things, of the use of conventional dynamic loudspeakers and the limited control of the sound produced by each loudspeaker in the array. Further, systems that produce high quality uniform masking sound fields have not been easily integratable with other sound producing systems such as paging systems and background music systems. As a result, separate systems generally have been required to meet these various needs.

Thus, a need exists for an improved system for delivering uniformly distributed masking sounds to a space for masking distracting noises that is easily installable, simple and easy to reconfigure and change with changing configurations of the space, easily tailored to accommodate changing acoustic environments within the space, and that integrates paging and other audio functions to eliminate the need for separate systems for these functions. It is to the provision of such a system that the present invention is primarily directed.

### SUMMARY OF THE INVENTION

Briefly described, the present invention, in one preferred embodiment thereof, comprises a unique wireless and remotely controllable sound enhancement system for providing masking sounds, paging announcements, and/or background music within a room or space having a suspended ceiling. The system, in one embodiment, includes a wireless remote control unit, a central paging transmitter mounted to the hard ceiling above the suspended ceiling, and an array of flat panel speaker units each mounted at a selected position within the suspended ceiling grid of the space. The flat panel speaker units are sized to be installed within a grid space normally occupied by a ceiling panel and have an exposed surface that architecturally matches and is indistinguishable from surrounding ceiling panels.

Each flat panel speaker unit is self-contained and includes a flat panel transducer for radiating sound into the space and a dedicated wireless electronics module containing an audio pre-amplifier and power amplifier for driving the flat panel transducer. In one embodiment, the electronics module also includes a system controller, a masking sound generator having a library of selectable masking sounds, an audio effects unit, and an audio enhancer. The system controller has an antenna for receiving wireless paging announcement signals and music signals from the central paging transmitter and for receiving wireless control signals and masking sound data uploads from the remote control unit. Control signals may be transmitted from the remote control unit to selected ones or to the entire array of speaker units for remotely adjusting the volume of each unit, adjusting audio effects such as equalization, and selecting a masking sound to be played from the masking sound generator's library of sounds. New masking and/or background sounds may be uploaded from the remote control unit to selected ones or all of the speaker units to update the library of sounds if desired.

The system controller of each speaker unit also is adapted to receive wireless radio frequency (RF) paging announcements from the central paging transmitter and to cause these paging announcements to be broadcast by the corresponding speaker unit. In this regard, the paging sounds themselves may be superimposed on or embedded within the masking sounds in such a way as to make them intelligible without disrupting the masking sounds. Alternatively, ducking may be used to reduce the level of masking sounds during a page. Each speaker unit preferably is independently selectable by an identification code such that a paging announcement transmitted by the central paging transmitter is broadcast over only selected ones of the speaker units. In this way, pages may be directed to selected areas of a space such that workers in other areas where the page is not needed remained undisturbed.

In operation, each of the self-contained speaker units is mounted at a selected location in the suspended ceiling grid of the space to form an array corresponding to the needs of the space. Since the speaker units are self-contained and not connected to other system components with wires, the configuration of the array is easily changed if desired simply by removing speaker units from the ceiling grid and reinstalling them at new locations as needed. With the speaker units installed and the paging transmitter located in a central location within radio range of the speaker units, preferably attached to the hard ceiling, masking sounds may be selected from the library of sounds in each speaker unit and these masking sounds are played and broadcast by each speaker unit. Because of the flat panel transducers and their distributed mode sound reproduction, these masking sounds tend to be much more diffuse and uniform at the level of occupants within the space than is the case with traditional dynamic loudspeakers, rendering the masking sounds more efficient. Further, an operator may easily adjust the volume and equalization of each of the speaker units independently to adjust for varying acoustical conditions in different parts of the space to improve further the quality and uniform nature of the sound field in the room.

When a paging announcement is required, it is transmitted by RF transmission from the central paging transmitter and received by the system controllers in the speaker units. As previously mentioned, the paging transmitter may transmit identification codes prior to transmitting the page to select predetermined ones of the speaker units for purposes of broadcasting the page. Thus, the page may be confined only to areas of the space where it is relevant without disturbing workers in other areas of the space.

In another embodiment, the electronics module includes, in addition to the pre and power amplifiers, a system controller, a masking sound generator, a masking sound pre-filter, an audio mixer, and a post filter including an equalization (EQ) function. This embodiment functions in a manner similar to that of the first embodiment, but does not include the audio enhancement and effects features of that embodiment. These functions generally are not required when the system is used with a high quality flat panel transducer that itself has enhanced audio response characteristics. The overriding concept of providing a tand-along self contained wireless panel with on-board masking sound generation is common to both embodiments.

Accordingly, a unique integrated sound enhancement system is now provided that addresses the problems and shortcomings of the prior art. The system is easily configurable and reconfigurable due to the modular self-contained nature of the flat panel speaker units, integrates masking noise, pages, and background music all in a single wireless remotely controllable system, provides for a diffuse and uniform sound field when producing masking sounds, permits independent and wireless adjustment of the volume and sound quality produced by each speaker unit, permits wireless selection of masking sounds from a masking sound library stored in each speaker unit as well as allowing for uploads of new sounds to the library, and can be made to blend architecturally with standard ceiling tiles within the space for a pleasing appearance. These and other features, objects, and advantages of the invention will become more apparent upon review of the detailed description set forth below taken in conjunction with the accompanying drawing figures, which are briefly described as follows.

### BRIEF DESCRIPTION OF THE DRAWINGS

FIG. 1 illustrates one prior art masking sound generating system wherein traditional dynamic loudspeakers within the plenum above a suspended ceiling direct sound upwardly to be reflected and diffused by the hard ceiling.

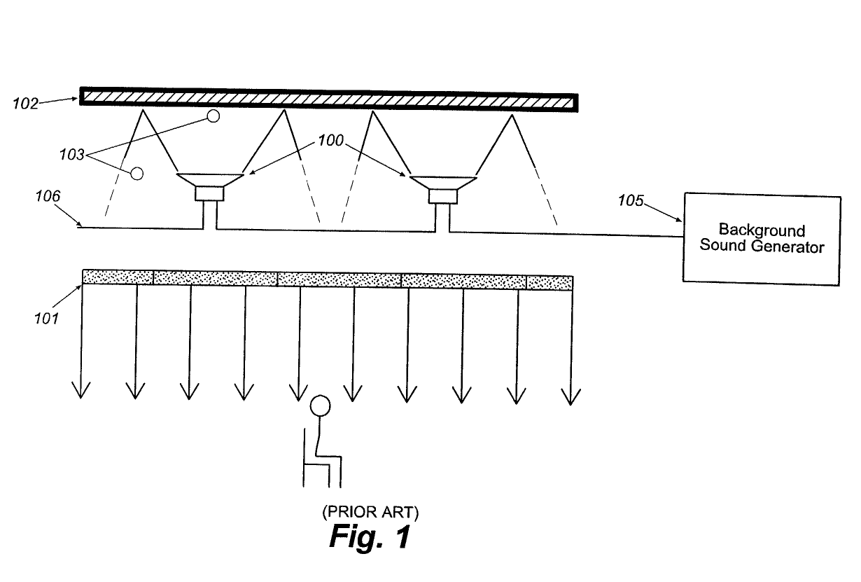

FIG. 2 illustrates another prior art masking sound generating system wherein traditional dynamic loudspeakers are mounted in ceiling panels and are directed downwardly into a space.

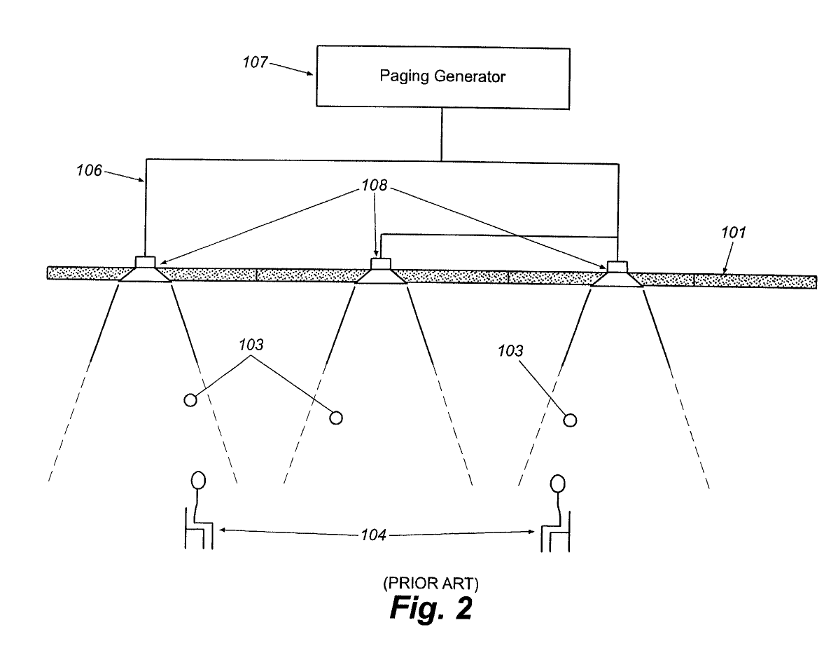

FIG. 3 illustrates a preferred embodiment of the masking sound generating system of the present invention including radio frequency controlled flat panel transducers, a central transmitter, and a remote controller for adjusting each In transducer and delivering selected sound signals thereto.

FIG. 4 is an electronic block diagram illustrating the major components of the radio frequency controlled flat panel transducer of the invention.

FIG. 5 is an electronic block diagram illustrating an alternative arrangement of components within a flat panel speaker unit according to the invention.

### DETAILED DESCRIPTION OF THE PREFERRED EMBODIMENTS

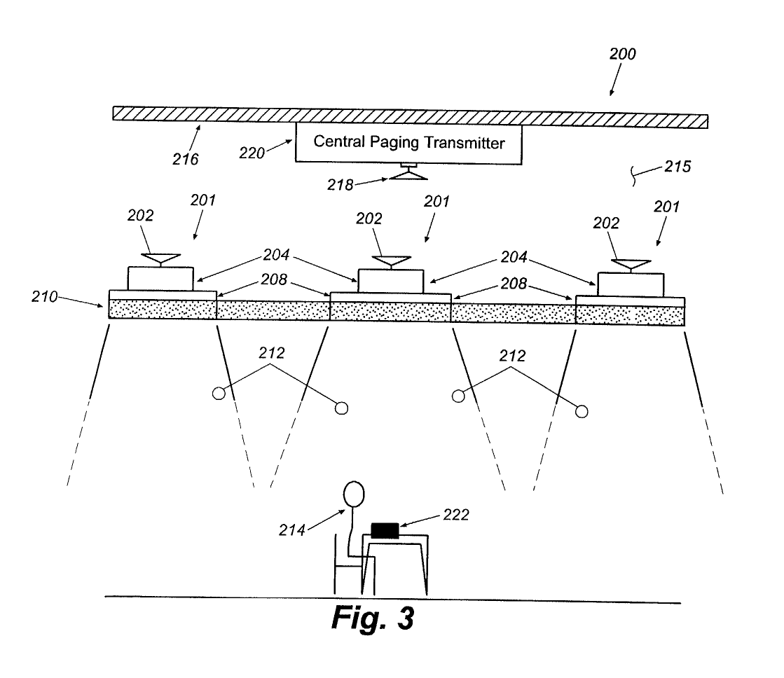

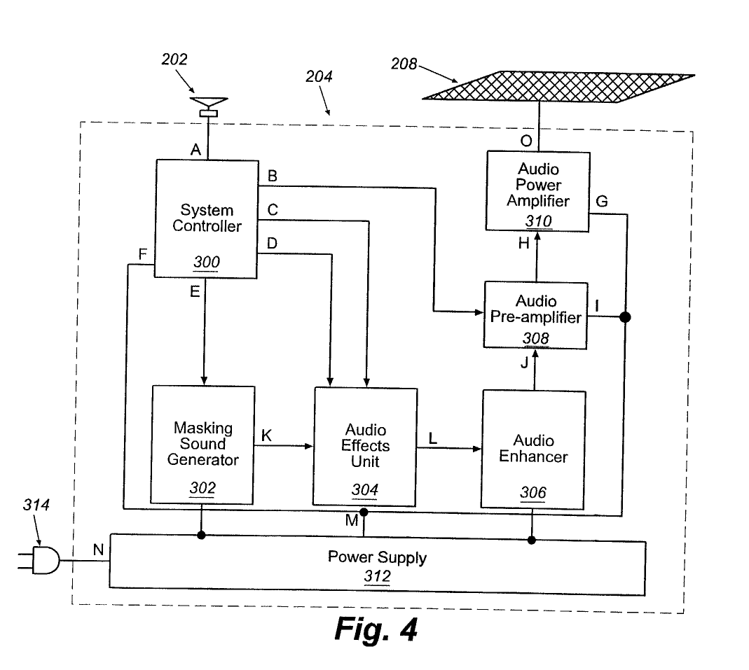

Referring now in more detail to FIGS. 3 and 4, wherein like numerals refer to like parts throughout the several views, FIG. 3 illustrates an architectural sound enhancement system that embodies principles of the present invention in a preferred form. The sound enhancement system 200 preferably is configured for installation in a space having a standard suspended ceiling 210, which is suspended beneath a hard ceiling 216. A plenum zone 215, which traditionally carries HVAC ductwork, wiring, plumbing, and the like, is formed between the hard ceiling and the suspended ceiling. A central paging transmitter 220 is mounted to the hard ceiling 216, preferably in a central location, and includes an antenna 218 for broadcasting a radio frequency carrier modulated with audio signals including, but not limited to, paging and/or background music signals. The transmitter also may be located elsewhere than on the hard ceiling 216 if desired.

An array of speaker units 201 are mounted within the grid structure of the suspended ceiling 210 for directing sound downwardly into the space beneath the ceiling, as indicated by radiation patterns 212. Each speaker unit 201 is wireless and self-contained and includes an audio transducer 208, an electronics module 204, and a radio antenna 202. The transducer 208 most preferably, but not necessarily, comprises a flat panel-type distributed mode transducer sized to be installed at a selected position within the grid of the suspended ceiling in place of a standard ceiling panel. With such a configuration, the speaker units 201 are easily arrayed in any desired pattern simply by installing them at the appropriate locations within the suspended ceiling grid. Furthermore, the flat panel transducers 208 also are preferred in the present invention because they produce a more diffuse, less directional, and more uniform sound field at the position of room occupants than traditional dynamic loudspeakers. Flat panel transducers are therefore more desirable for the effective production of uniformly distributed masking noise.

As described in more detail below, the electronics module 204 of each speaker unit 201, in the embodiment of FIG. 4, includes an on board dedicated audio pre-amplifier and power amplifier for driving the flat panel transducer 208. A masking sound generator, which includes a stored library of selectable masking sounds, is included in the electronics module 204 for providing masking sound audio signals to the audio pre-amplifier for reproduction. The electronics module 204 also may contain an audio effects unit for providing equalization, compression, ducking, and other audio effects as necessary to tailor and optimize the character of the sound produced by the unit. Finally, an audio enhancer preferably is provided in the electronics module 204 when a lower quality flat panel transducer 208 is used. The audio enhancer, which is available commercially from, for example, SRS Technologies, includes hardware and software that enhances electronic audio signals to improve the bass response and intelligibility of spoken voice sounds produced by the flat panel transducer 208. While the techniques employed by such enhancers vary, and generally are outside the scope of the present disclosure, one technique involves artifically enhancing the periodic higher frequency harmonics of portions of the sound signal having lower fundamental frequencies. The human brain interprets the resulting sound as having enhanced bass at the low fundamental frequencies; however, very little if any additional signal at these lower fundamental frequencies is actually present. Accordingly, the perception of increased bass is created without actually increasing the level of bass portions of the sound.

A system controller is provided in the electronics module 204. The system controller is coupled to the antenna 202 and includes an RF receiver for receiving and demodulating RF signals received by the antenna. The system controller, through its RF receiver, may receive audio signals such as, for example, paging announcements, from the central transmitter 220 and also may receive control signals, such as volume, audio effects, and masking sound selection signals from the remote control unit 222, which, in turn, is operated by a human operator 214.

The human operator 214, using the remote control unit 222, may issue certain control commands to one or more of the speaker units 201 to control various aspects of the sound produced by the units. For example, the operator may independently or collectively adjust the volume of each speaker unit 201 by issuing appropriate volume control commands and may adjust the equalization curve applied to audio signals to, for example, custom contour the masking sounds in the frequency domain, by issuing corresponding equalization commands. Further, the operator may issue commands using the remote control unit 222 to select from among the library of masking sounds stored in the library of the masking sound generator. For example, the masking sound library may contain, in digitally stored form, a variety of possible masking and/or background sounds including “health sounds” such as heart beat, brain waves, body cycles, and others; “ecological sounds” such as bird sounds, ocean waves, waterfall sounds and others, as well as traditional masking sounds such as white or pink noise sounds tailored to mask certain distracting or annoying noises within the space. Research has indicated that the introduction of, for example, nature or body sounds into the workspace at proper levels can enhance the productivity of workers. Such sounds may be embedded within traditional white or pink noise masking sounds or may be reproduced apart from such traditional masking sounds. A wide variety of other sounds may be stored in the library as well, and the present invention is intended to encompass any and all such possible sounds. To select a particular sound from the library, the operator need only issue the appropriate command from the remote control unit 222 and the command, once received by one or more selected speaker units 201, is provided to the masking sound generator to cause it to generate or “play” the selected sound or sounds.

In addition simply to selecting a masking sound from the masking sound library, the operator also may upload new sounds to the library from the remote control unit 222. This is accomplished by issuing an upload command to one or more of the speaker units 201 followed by the transmission of a digital audio file to be stored in the library. Thus the masking sounds library may be continuously updated and changed as desired to provide a changing variety of possible masking and background sounds in the space. The uploading also may be accomplished from a remote location over a communications link such as a modem, RS232, IEEE488, or other appropriate connection. This provides the opportunity for masking and background sound services akin to cable TV services that maintain and update the library of sounds for a fee.

In addition to control signals and sound file uploads from the remote control unit 222, each of the speaker units 201 also may receive paging announcements and other voice and/or music signals transmitted by the central paging transmitter 220. When such signals are transmitted, they are received by the antennae and receivers of each speaker unit and demodulated to extract the audio signal from the RF transmission. This audio signal is then delivered by the system controller within the speaker unit to the audio pre-amplifier, which pre-amplifies the signal and delivers it to the power amplifier, which, in turn, drives the transducer to broadcast the page into the space. The independent and self-contained design of the speaker units makes creative or targeted paging simple. For example, it is contemplated that each speaker unit will be provided with an internally stored identifier and that each unit may be activated by transmitting the unit's corresponding identifier. It is thus a simple matter to broadcast a page only in a selected area or selected areas of the space by activating only the speaker units within the selected area or areas.

Further, since the volume and audio effects of each speaker unit also can be independently set and adjusted by the operator, the sound level and sound character can easily be adjusted to match the various acoustic environments within the space. For example, speaker units positioned in acoustically absorbent regions of the space may have their equalization adjusted to as provide a brighter sound and their volume adjusted to be a bit greater than speaker units in acoustically reflective regions of the space to provide the perception of a uniform sound field. As mentioned above, a uniform sound field is important for producing masking sounds to minimize the perception of the masking sound as an occupant moves about the space. In any event, it will be appreciated that the present invention provides not only easy wireless configurability, but also the ability to control the output of each speaker unit independently from the others using a remote control that may be located anywhere within range of the speaker units.

FIG. 4 illustrates, in functional block diagram form, one preferred embodiment of the electronics module 204 and major internal components thereof. The electronics module 24, illustrated in phantom outline, includes an antenna 202 for detecting RF signals modulated with control or audio information as described above. The antenna 202 is coupled to a system controller 300, which includes a radio receiver (not shown) for receiving the RF signals detected by the antenna 202 and demodulating the signals to extract the control and/or audio information therefrom. The system controller 300 also houses a microprocessor or micro-controller that is appropriately programmed to interpret the demodulated signals and appropriate electronic switching networks to route them to the other components within the electronics module depending on the nature of the signals received, as described in more detail below. A masking sound generator 302 is included in the electronics module and is provided with internal memory (not shown) sufficient to store a library of masking and/or background sounds such as those discussed above and others. The masking sound generator also includes appropriate electronics such as, for example, D/A converters and pre-amplifiers for “playing” the masking and/or background sounds to produce audio signals corresponding to the sound being played.

The audio signals produced by the masking sound generator 302 are directed to an audio effects unit 304 within the electronics module. The audio effects unit contains hardware and/or software that can apply to audio signals certain audio effects such as, for example, equalization, compression, gating, ducking during a page, and others. The effected audio signal from the audio effects unit 304 is then directed to audio enhancer 306, which is a commercially available product designed to improve the sound produced by flat panel transducers, such as the flat panel transducer 208 of the present invention. In essence, the audio enhancer contains hardware and software that adapts the audio signal as discussed above so that, when amplified and presented to the flat panel transducer, improved bass response and vocal intelligibility are perceived by a listener.

The enhanced audio signals are directed from the audio enhancer 306 to an audio pre-amplifier 308, which essentially provides controllable gain adjustment for the audio signal presented thereto and provides an impedance match between the output of the audio enhancer and the power amplifier. The audio power amplifier 310, which preferably is capable of delivering at least 200 watts of audio power, receives the effected, enhanced, and pre-amplified audio signals from the pre-amplifier and amplifies them to a level sufficient to drive the flat panel transducer 208, thus projecting sound into the space 212 (FIG. 3). A power supply 312 is connected to a standard source of electrical power via electrical connector 314 and supplies appropriate operating power for the various electronic components of the electronics module 204.

The system controller 301 is operatively connected to various ones of the components of the electronics module to deliver control signals or audio signals thereto as the case may be. More specifically, the system controller 300 is connected to the masking sound generator 302 and is programmed to deliver masking program selection messages (E) thereto when such messages are received via RF transmission from the remote controller 222 (FIG. 3). Such messages cause a masking or background sound stored in the library of the masking sound generator to be selected according to the operator's wishes and “played” by the generator to project the selected sound into the space. In addition, new masking or background sounds can be uploaded to the system controller 300 from the remote controller 222 (or from a remote location through an auxiliary communications link). In that event, the system controller 300 is programmed to prompt the masking sound generator to receive a new sound and to deliver the new sound to the masking sound generator for storage in its library of sounds. Thus, masking and background sounds are easily updated and changed by remote control with the present invention.

The system controller 300 also is connected to the audio effects unit 304 and is programmed to deliver effects adjustment messages (C) received from the remote controller 222 to the audio effects unit to adjust one or more audio effects applied to audio signals. For example, an operator may wish to brighten the sound produced by one or more speaker units or to tailor the frequency spectrum of a masking sound, in which case an appropriate equalization adjustment might be made in, for example, ⅓ octave increments, by increasing the gain of the signal at mid and higher frequencies. The appropriate adjustment is entered into the remote controller 222, which transmits the adjustment to the selected speaker unit or units. The adjustment is received by the system controller and delivered to the audio effects unit 304, which responds by adjusting the equalization of the audio signal according to the remotely entered instructions.

The system controller also is configured and programmed to deliver demodulated paging announcement messages received wirelessly from the central paging transmitter 220 to the audio effects unit 304 where effects such as equalization and ducking may be applied and the resulting signal forwarded on through the system to drive the transducer 208. Thus, the system of the present invention not only provides a unique masking and background noise generating audio system, it also integrates a paging and announcement system that can be used to page individuals within the space. In fact, as mentioned above, the paging and announcement system is extremely versatile since any one or a group of speaker units may be selected by remote control for a particular page or announcement to direct the announcement only where it is needed and to leave other areas undisturbed by the announcement. In such an event, the masking or background noise being played by the system will continue to play on the unselected speaker units, thus further masking the distracting sounds of the page or announcement in another region of the space. Any combination of speaker units can be selected in this way to make, for example, perimeter announcements, internal announcements, or announcements only in selected departments or areas.

Finally, the system controller 300 is connected to the audio pre-amplifier 308 and is programmed to deliver volume control messages received from the remote controller 222 to the pre-amplifier to control the overall volume of sounds produced by the speaker unit 201. Accordingly, not only can the quality of the sounds be adjusted by transmitting appropriate effects change messages, the overall volume may also be adjusted by transmitting appropriate volume control messages. Thus, the system of the present invention is highly controllable and adjustable, each speaker unit may be adjusted independently of the others, and the entire system may be fine tuned, all by remote control, to provide a uniformly disbursed and evenly distributed sound field throughout an entire space.

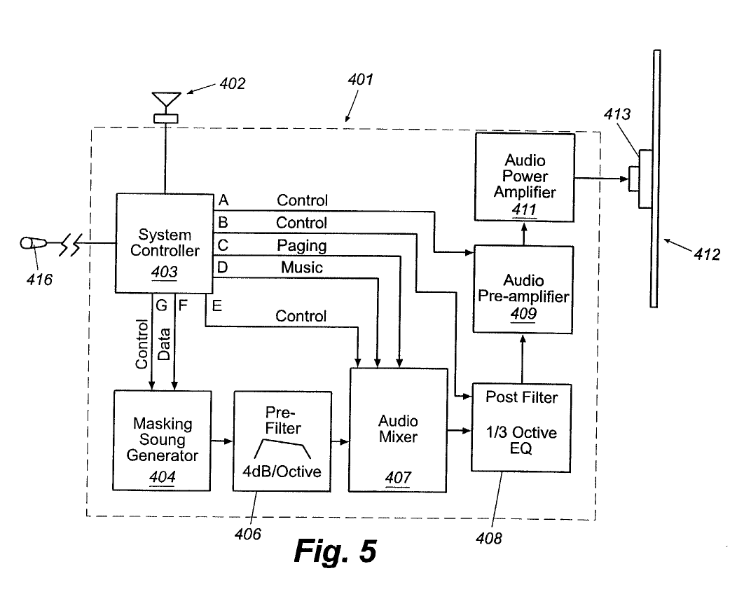

FIG. 5 illustrates an alternate embodiment and arrangement of electronic components within the on-board electronics module for accomplishing the goals and purposes of the present invention. In this embodiment, the electronics module 401, which is a part of and on board the flat panel speaker assembly, includes an antenna 402 for receiving radio frequency signals, a system controller 403, a masking sound generator 404, a masking sound pre-filter 406, an audio mixer 407, a post filter 408, an audio pre-amplifier 409, and an audio power amplifier 411. The output of the power amplifier 411 is coupled to an electro-mechanical driver or exciter 413 that, in turn, imparts sonic vibration to the flat panel radiator 412 of the speaker for reproducing program material and masking sound. As with the prior embodiment, the system controller 403 receives radio frequency signals from the antenna 402 and includes a demodulator for demodulating control data and program material from the signal. Information provided to the system by radio frequency transmission includes paging and music program material, control signals, and masking sound files to be downloaded to the masking sound generator. The masking sound generator 404 includes appropriate electronics such as D/A converters and pre-amplifiers for “playing” the digital masking sound data files to produce a masking sound audio signal.

The masking sound audio signal from the masking sound generator is directed to the pre-filter 406 for shaping the masking sound audio signal in the frequency domain to provide maximum efficiency. More specifically, since the sensitivity of the human ear varies with frequency (higher frequencies at a constant level are interpreted by the human ear as being louder than lower frequencies), it is desired to contour the audio level of the masking sound as a function of frequency to provide a masking sound output that is equally effective for masking applications at all frequencies of interest. One way known in the industry for accomplishing this is to apply a “constant loudness” filter to the signal. A typical constant loudness filter may, for instance, apply a 5 dB per octave level reduction curve to a masking sound such as white or pink noise over a specified frequency range. In this way, the resulting output “sounds” to a listener as though it is equally loud at all of its included frequencies. With regard to the present invention, it has been discovered through experimentation that a strict 5 dB per octave equal loudness filter is not ideal. Instead, applicants have discovered that a less aggressive 4 dB per octave filter produces a masking sound that is more effective to mask annoying ad distracting sounds in a work environment. Accordingly, the pre-filter preferably includes a 4 dB per octave filter, although other curves may be applied depending upon application specific requirements. The applicants have coined the phrase “equal annoyance” curve to its 4 dB per octave filter. In addition to this level shaping filter, the pre-filter also may include high and low pass filters to remove signals above and below frequencies that are to be masked and may include other filters as desired to provide other shaping and filtering of the masking sound filter.

As mentioned above, the system controller 403 is adapted to receive and demodulate radio frequency transmissions that may include control commands, paging signals, music signals, masking data files, and perhaps other types of information. Demodulated audio program material such as paging and music signals C and D are directed to the audio mixer 407 as is the pre-filtered masking sounds form the pre-filter 406. Mixer control signals E may be received by the system controller and directed to the audio mixer to control the mixer to appropriately mix the various audio signals. For instance, it may be desired to duck or reduce the volume of, or even mute, masking sounds and music when a page is received by the system controller to be broadcast. Such mixer control functions may be provided by a user via radio signals as previously mentioned, or they may be built-in or automatic functions of the system controller if desired. In any event, the audio mixer 407 controls the mixing and relative volumes of the various audio input signals that are directed to the mixer.

As with the previously discussed embodiment, control signals G and masking sound data files F may flow from the system controller to the masking sound generator. The control signals G may be used to select a masking sound from the library of the masking sound generator to be played or to prompt the generator to receive new masking sound data files to be downloaded by the system controller. Other types of control signals may be provided if desired.

The mixed audio signals form the mixer 407 are delivered to the post filter 408. The post filter 408 is provided to shape the audio output signals of the system as desired to accommodate a variety of different acoustical spaces into which the sound is to be projected. For this purpose, the post filter preferably includes at least a ⅓ octave equalization (EQ) function that can be set or adjusted, preferably through control signals B received from a user through the system controller. For example, when the system is used in a bright or reflective space, the EQ may be set to reduce the high frequency content of the program material since a reflective space tends to accentuate such high frequencies. In contrast, in an acoustically dead or absorptive space, the EQ may be set to increase high frequency content to provide a pleasing and natural audio program to workers in the space. The post filter can be set differently for each flat panel loudspeaker panel of an array of panels in a space to compensate for differing audio characteristics in various locations within the space. Finally, it also is contemplated that the post filter be controlled automatically, in real time, and adaptively to adjust for room audio characteristics. For this purpose, a microphone 416 may be coupled to the system controller for “listening” to the sound field within the space. The system controller is then programmed to analyze the sound field and to send appropriate control signals to the post filter to shape and contour reproduced sound as necessary to provide the most desirable results for a particular space. For example, the character of the sound may be modified in real time to compensate for changing HVAC sounds, ambient noise of a crowd of people, changing acoustic characteristics because of moved furniture, and otherwise. Such an adaptive system is contemplated by and included within the scope of the present invention.

From the post filter, the audio signal is delivered to the audio pre-amplifier 409, the gain of which may be controlled by control signals A from the system controller. Finally, the signal is delivered to the inputs of the audio power amplifier 411, which, in turn, drives the electromechanical driver 413 of the flat panel speaker 412 to reproduce sound within a space.

The invention has been described herein in terms of preferred embodiments and methodologies. It will be understood by those of skill in the art, however, that variations on the preferred embodiments are possible within the scope of the invention. For example, the system is preferably used with flat panel transducers as described, but may also be equally effective in many applications when used with traditional dynamic loudspeakers. In such a configuration, the audio enhancer of the preferred embodiment may not be a desired or needed component. Further, the system has been illustrated installed in a suspended ceiling. However, the invention is not limited to such an installation and may be used in traditional ceilings or even in walls or partitions used to define workspaces within a larger room. The various subsystems that form the system of the invention also are believed to be unique in their own right. For example, a simple wireless paging system with remotely controlled equalization and volume control may well be implemented without masking and background sounds, all within the scope of the present invention. Likewise, wireless remotely controllable masking sound system without paging capabilities may also be implemented within the scope of the invention. The basic inventive concept of a loudspeaker system with on-board masking sound generation is itself within the scope of the invention disclosed herein. These and many other additions, deletions, and modifications might well be made by those of skill in the art without departing from the spirit and scope of the invention as set forth in the claims.

What is claimed is:

1. A system for producing selected sounds in a space having a suspended ceiling, a plenum above the suspended ceiling, and a hard ceiling above the plenum, said system comprising:
at least one flat panel transducer selectively positioned in said suspended ceiling for directing sound into the space when driven by an audio signal;
an electronics module coupled to said flat panel transducer, said electronics module including a sound generator for generating audio signals and an amplifier coupled to receive audio signals produced by said sound generator, amplify the audio signals, and drive said flat panel transducer to produce sound corresponding to the audio signals; and
a system controller in said electronics module coupled to said sound generator, said system controller being configured to receive control signals wirelessly from a remote location and to cause said sound generator to generate sound signals as directed by the control signals.

2. The system of claim 1 and further comprising a remote control unit for wirelessly transmitting control signals to said system controller to control the generation of sounds by said flat panel transducer.

3. A system for producing selected sounds in a space as claimed in claim 1 and further comprising an audio effects unit in said electronics module, said audio effects unit being coupled to said sound generator and to said system controller and being configured to receive control signals from said system controller and to apply effects to the sound signals according to said control signals.

4. A system for producing selected sounds in a space as claimed in claim 3 and wherein said effects unit includes an audio equalizer.

5. A system for producing selected sounds in a space as claimed in claim 1 and further including an audio enhancer in said electronics module for improving the response of the flat panel transducer.

6. A system for producing selected sounds in a space as claimed in claim 2 and wherein said remote control unit includes a radio frequency transmitter and said system controller includes an antenna for receiving radio frequency transmissions from said remote control unit.

7. A system for producing selected sounds in a space as claimed in claim 1 and further comprising an array of flat panel transducers mounted in the suspended ceiling, each flat panel transducer having an associated electronics module, said remote control unit being adapted to transmit control signals to each speaker unit independently to control the sounds produced by each of said flat panel transducers independently of the other flat panel transducers.

8. A system for producing selected sounds in a space as claimed in claim 1 and wherein said central paging transmitter is mounted on the hard ceiling.

9. A system for projecting sound into a space, said system comprising a plurality of audio transducers configured and positioned to direct sound into the space upon activation by an amplified audio signal, an electronics module including a sound generator and an audio amplifier associated with each of said audio transducers for generating audio signals, amplifying the audio signals, and driving the corresponding audio transducer, a system controller in each of said electronics modules for receiving control signals from a remote location and controlling the generation of audio signals by said sound generator according to said control signals, and a remoter controller for transmitting selected control signals to said system controllers to control the production of sound by each of said transducers independently of the others of said transducers.

10. An architectural sound enhancement system comprising:
an array of speaker units each having an audio transducer, a sound generator, an audio amplifier, and a system controller;
said system controller of each speaker unit being adapted to receive wireless control signals from a remote location and to control said sound generator according to the received control signals; and
a remote control unit for selectively transmitting wireless control signals to said system controllers of said speaker units to control the production of sound produced by said units.

11. An architectural sound enhancement system as claimed in claim 10 and further comprising a paging transmitter for transmitting wireless paging messages, said system controller of each of said speaker units being adapted to receive paging messages transmitted by said paging announcement transmitter and to broadcast the paging messages into the space.

12. An architectural sound enhancement system as claimed in claim 10 and wherein said audio transducers comprise flat panel transducers.

13. An architectural sound enhancement system as claimed in claim 10 and wherein said speakers units are mountable in a suspended ceiling grid.

14. An architectural sound enhancement system as claimed in claim 10 and wherein said sound generator includes a library of stored sounds and wherein said control signals include directions to select sounds from said library of stored sounds for reproduction by said speaker unit.

15. An architectural sound enhancement system as claimed in claim 14 and wherein said system controller is adapted to receive uploads of new sounds from said remote control unit and to direct said sound generator to store the new sounds in said sound library.

16. An architectural sound enhancement system as claimed in claim 10 and further including and audio effects unit in said speaker unit for adjusting the quality of sound produced thereby, said system controller being adapted to receive wireless effects control signals from said remote controller and to adjust said effects unit according to the received control signals.

17. An architectural sound enhancement system as claimed in claim 10 and wherein said audio transducer is a flat panel transducer and wherein said speaker unit further includes an audio enhancer to enhance the quality of sound produced by said flat panel transducer.

18. An architectural sound enhancement system as claimed in claim 10 and further comprising an audio pre-amplifier, said system controller being adapted to receive wireless volume control signals from said remote control unit and to adjust the volume level of said audio pre-amplifier according to said volume control signals.

19. A system for producing selected masking sounds in a space having a suspended ceiling, said system comprising:
at least one flat panel transducer assembly selectively positioned in said suspended ceiling for directing sound into the space when driven by an audio signal;
an electronics module coupled to said flat panel transducer, said electronics module including a masking sound generator for generating masking sound audio signals and an amplifier coupled to receive the masking sound audio signals produced by said sound generator, amplify the audio signals, and drive said flat panel transducer to produce masking sounds; and
a system controller in said electronics module coupled to said sound generator, said system controller for controlling the production of masking sound audio signals by said masking sound generator.

20. The system of claim 19 and wherein said system controller is configured to receive control signals wirelessly from a remote location and to cause said sound generator to generate sound signals as directed by the control signals.

21. The system of claim 19 and further comprising a pre-filter in said electronics module for filtering the masking sound signals generated by said masking sound generator.

22. The system of claim 21 and wherein said pre-filter includes a predetermined dB pre octave filter for shaping the level of said masking sound signals as a function of frequency.

23. The system of claim 22. and wherein said dB per octave filter is a 4 dB per octave filger.

24. The system of claim 21 and further comprising a post filter in said electronics module for shaping the pre-filtered masking sound signals to compensate for variations in the acoustic characteristics of a room in which said system is installed.

25. The system of claim 20 and wherein said system controller is further configured to receive radio frequency transmissions including ancillary audio program material to be reproduced by said flat panel speaker.

26. The system of claim 25 and wherein said ancillary audio program material includes paging signals.

27. The system of claim 25 and wherein said ancillary audio program material includes background music signals.

28. A flat panel speaker system for installation in a suspended ceiling grid, said flat panel speaker system comprising a flat panel transducer, a masking sound generator for generating masking sound signals, an audio amplifier for amplifying the masking sound signals and driving the transducer to produce and project masking sounds, and a controller for controlling the production of masking sound signals by said masking sound generator.

29. A flat panel speaker system as claimed in claim 28 and further comprising a radio frequency receiver in said controller for receiving radio frequency signals and controlling said masking sound generator in response thereto.

30. A flat panel speaker system as claimed in claim 29 ad wherein said receiver also receives ancillary audio program signals and wherein said controller is configured to direct said received signals to said audio amplifier for reproduction by said flat panel transducer.
